(19) United States
(12) Patent Application Publication
(10) Pub. No.: US 2006/0000369 A1
(43) Pub. Date: Jan. 5, 2006

(54) Mixer filter

(76) Inventor: Maxwell Hsu, Tao-Yuan (TW)

Correspondence Address: Yi-Wen Tseng, 4331 Stevens Battle Lane, Fairfax, VA, 22033, US

(21) Appl. No.: 10/879,113

(22) Filed: Jun. 30, 2004

(51) Int. Cl. A23N 1/00

(52) U.S. Cl. 99/511

(57) ABSTRACT

A mixer filter that is fastened to a transmission shaft of a mixer is provided. The mixer filter includes a filter body and a blocking member. The filter body includes a base, a filter web and a top ring. The base includes a circular plate upwardly connecting the filter web along the peripheral of the circular plate. The filter web forms a hollow conical shape that has a larger upper radius and a smaller lower surface. The top surface of the filter web connects the top ring. The blocking member is formed on the top ring of the filter body. Accordingly, the juice and the fruit meat can completely be separated so as to enhance the juicing rate.

### BACKGROUND OF THE INVENTION

The present invention relates generally to a filter of a mixer, and more particularly to a filter that is disposed on a transmission shaft of the mixer. By applying the centrifugal force to the juice of fruit meat, the juice and the fruit meat residuals are completely separated, thereby enhancing the juicing rate.

Modern people are more and more conscious about dietary health. Since vegetables and fruits are rich in various kinds of vitamins, they are beneficial to the immune system of a human body. On the other hand, each vegetable or fruit comprises different nutritious facts. One can employ a mixer to grind different kinds of vegetables and fruits and to get a cup of highly nutritious and delicious juice. However, the primary factor affecting the juicing rate of a mixer is the design of filter structure. Therefore, the present invention provides a new mixer filter design that can optimize the juicing rate.

A conventional mixer filter is disclosed in Taiwanese new utility patent no. 493417. The mixer filter is a conical circular plate with a larger upper radius and a smaller lower radius. The circular plate includes an inclination surface with a predetermined slope. When inserting the vegetables and fruits into the mixer, the cutting blades of the mixer grind the vegetables and the fruits. By employing the centrifugal force on the circular plate, the juice and the fruit meat are separated. The juice then flows into the juice collection container via the holes of the filter. On the other hand, the fruit meat is thrown to the waste container along the inclination surface, thereby separating the juice and the fruit meat.

However, since the filter of the conventional mixer is linearly inclined, the fruit meat is thrown away along the inclination surface as soon as it is grounded. Consequently, the juice is not completely separated from the fruit meat, leaving the juicing rate to be only from 40% to 55%. This indeed is a tremendous amount of wastage.

Therefore, the inventor of the present invention devoted himself to developing a new mixer filter that can resolve the above drawbacks, as will be described in detail hereinafter.

### BRIEF SUMMARY OF THE INVENTION

The present invention is to provide a mixer filter that employs a blocking member disposed on a top ring of the filter body. The fruit meat that contains more juice encounter larger centrifugal force, which will hit the blocking member and fall back to the filter body so as to continue the filtration process for the second time. On the other hand, the fruit meat that contains less juice will be thrown away directly to a waste container, thereby enormously enhancing the juicing rate.

The mixer filter of the present invention includes a filter body and a blocking member. The filter body includes a base, a filter web and a top ring. The base includes a circular plate upwardly connecting the filter web along the peripheral of the circular plate. The filter web forms a hollow conical shape that has a larger upper radius and a smaller lower surface. The top surface of the filter web connects the top ring. The blocking member is formed on the top ring of the filter body, so as to separate the juice and the fruit meat.

### BRIEF DESCRIPTION OF THE DRAWINGS

FIG. 1 schematically illustrates a mixer filter in accordance with one embodiment of the present invention.

FIG. 2 is a sectional view of the filter of the present invention.

FIG. 3 is a sectional view of the filter of the present invention in combination with a mixer.

FIG. 4 schematically illustrates a mixer filter in accordance with another embodiment of the present invention.

### DETAILED DESCRIPTION OF THE INVENTION

In order to better understanding the features and technical contents of the present invention, the present invention is hereinafter described in detail by incorporating with the accompanied drawings. However, the accompanied drawings are only for the convenience of illustration and description, no limitation is intended thereto.

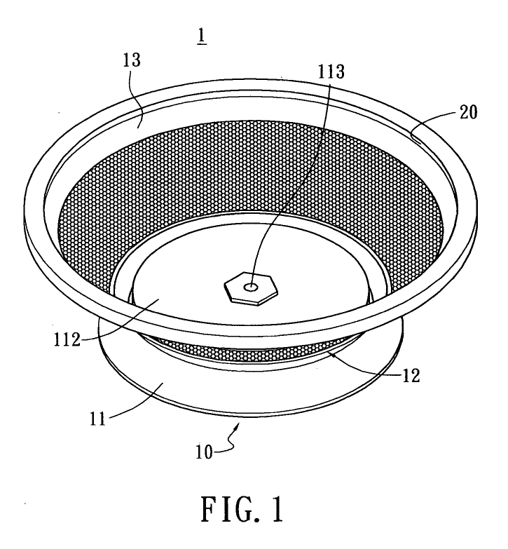

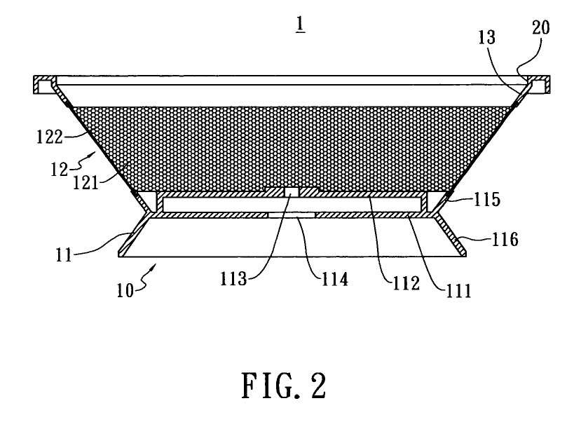

Referring to FIG. 1 and FIG. 2, a perspective view and a sectional view of a mixer filter of the present invention are respectively illustrated. The mixer filter 1 includes a filter body 10 and a blocking member 20.

The filter body 10 includes a base 11, a filter web 12 and a top ring 13. The base 11 is preferably made of plastic material, which includes a circular plate 111 and a platform 112 protrusively formed on the plate 111. The platform 112 has a hole 113 at the central portion thereof corresponding to a path 114. In addition, the base 11 includes an upper circular plate portion 115 and a lower circular plate portion 116 extending respectively from the peripheral of the circular plate 111. The top peripheral of the upper circular plate portion 115 connects the filter web 12. The filter web 12 is preferably made of stainless steel material, which is formed by soldering a plurality of fan-shaped plate 121. The filter web 12 is thus formed into a hollow conical shape with a larger upper radius and a smaller lower radius. A plurality of web holes 122 is formed on the fan-shaped plate 121. The web holes 122 can be circular, oval or in any possible geometrical shape. The filter web 12 connects the top ring 13 through the upper surface thereof. The inner surface of the top ring 13 inclines in accordance with the inclination of the filter web 12 and extends the inclination of the filter web 12.

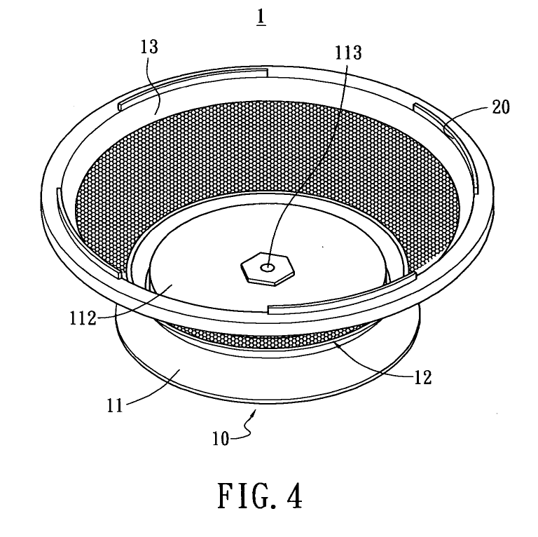

The blocking member 20 can also be made of plastic material, which is circular in shape. The blocking member 20 can be integrated with the top ring 13 of the filter body 10, or fastened or screwed on the top ring 13 of the filter body 10. In this particular embodiment, the blocking member 20 is integrated with the top ring 13, which extends directly upward from the top ring 13. The angle formed between the blocking member 20 and the filter web 12 is much larger than 90 degrees. Moreover, the blocking member 20 can also be discontinuously formed on the top ring 13 of the filter body 10, as shown in FIG. 4. When grinding the vegetables or fruits with less juice, the blocking member 20 of the mixer filter 1 can achieve better exhaustion result.

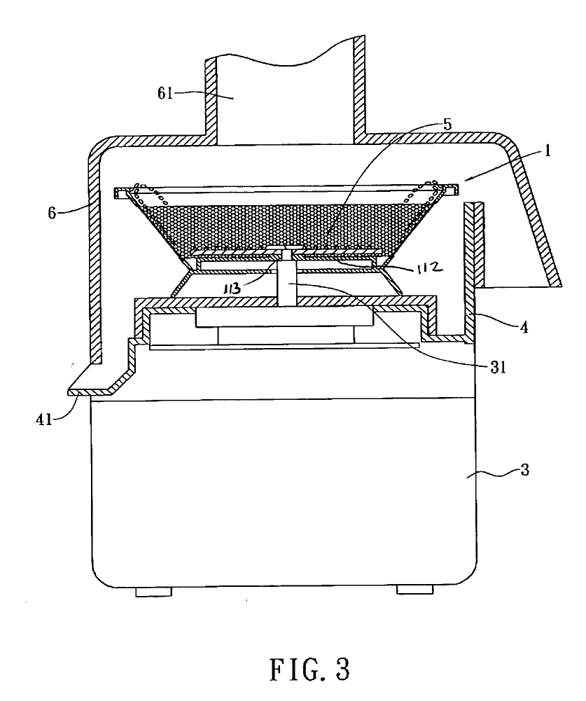

Referring to FIG. 3, a sectional view of the mixer filter 1 in combination with a mixer is illustrated. As shown, the mixer filter 1 is firmly disposed on the mixer. The mixer includes a lower mount 3, an upper mount 4, a juicing plate 5 and a cover 6. A transmission shaft 31 is disposed at the center of the lower mount 3. The transmission shaft 31 connects the mixer filter 1 and the juicing plate 5. The top surface of the transmission shaft 31 contacts the platform 112 of the base 11, and is firmly secured through the hole 113 of the platform 112 by means of fastening elements, such as screws. The mixer filter 1 is thus sandwiched between the juicing plate 5 and the lower mount 3. The upper mount 4 is movably disposed on the lower mount 3, which has a juice output 441. The cover 6 is disposed on the upper mount 4, which has a cylindrical material input 61 formed thereon. The material input 61 is positioned at the center of the juicing plate 5 so as to throw various vegetables or fruits therein through the material input 61.

By employing the combination as set forth above, the various vegetables or fruits are ground into juice and fruit meat by using the cutting blades of the juicing plate 5. The grounded juice flows to the juice output 41 of the upper mount 4 directly through the web holes 122 of the filter web 12. The fruit meat however is moved upward along the fan-shape plate 121 of the filter web 12 in response to the centrifugal force. The fruit meat that contains more juice moves upward closely contacting the plate 121 of the filter web 12. The fruit meat will hit the internal surface of the blocking member 20. Thereafter, the fruit meat that contains more juice will fall back to the filter body 10 so as to continue the filtration process for the second time. Furthermore, the fruit meat that contains less juice will become lighter in weight, which can easily be thrown away from the mixer filter 1 to the waste container in response to the centrifugal force on the fruit meat. Therefore, the juicing rate is largely enhanced.

In summary, the mixer filter of the present invention indeed contain patentable subject matter that is consistent with the utility, novelty and non-obviousness requirements as set forth in the patent law. Therefore, a grant of letters patent for the present invention is respectively requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

1. A mixer filter fastened on a transmission shaft of a mixer, comprising:
a filter body comprising a base, a filter web and a top ring, the base having a circular plate upwardly connecting the filter web along the periphery thereof, the filter web forming a hollow conical shape that has a larger upper radius and a smaller lower surface and connecting the top ring through the top surface thereof; and
a blocking member formed on the top ring of the filter body.

2. The mixer filter as recited in claim 1, wherein the filter body integrates the blocking member.

3. The mixer filter as recited in claim 1, wherein the blocking member is made of plastic material.

4. The mixer filter as recited in claim 1, wherein the blocking member is circular in shape.

5. The mixer filter as recited in claim 1, wherein the blocking member is fastened on the top ring of the filter body.

6. The mixer filter as recited in claim 1, wherein the angle between the blocking member and the filter web of the filter body is larger than 90 degrees.

7. The mixer filter as recited in claim 1, wherein the blocking member is discontinuously disposed on the top ring of the filter body.

8. A mixer filter fastened on a transmission shaft of a mixer, comprising:
a filter body comprising a base, a filter web and a top ring, the base having a circular plate upwardly connecting the filter web along the peripheral thereof, the filter web forming a hollow conical shape that has a larger upper radius and a smaller lower surface and connecting the top ring through the top surface thereof; and
a blocking member which is discontinuously disposed on the top ring of the filter body.
